(19) United States
(12) Patent Application Publication
(10) Pub. No.: US 2003/0030346 A1
(43) Pub. Date: Feb. 13, 2003

(54) Rotor body and method for producing rotor bodies

(76) Inventors: Siegfried Schustek, Ditzingen (DE); Stefan Ossenkopp, Hildesheim (DE); Peter Franz, Diekholzen (DE)

Correspondence Address: Striker Striker & Stenby, 103 East Neck Road, Huntington, NY, 11743, US

(21) Appl. No.: 10/148,625

(22) PCT Filed: Sep. 22, 2001
(86) PCT No.: PCT/DE01/03670

(30) Foreign Application Priority Data
Oct. 7, 2000 (DE) 100 49 700.4

(51) Int. Cl. H02K 1/00

(52) U.S. Cl. 310/216

(57) ABSTRACT

The present invention concerns a rotor body for an electrical machine, in particular for a starter or a starter-alternator, whereby the rotor body comprises grooves (1) having one open end (2) that are provided to house winding elements (3), and whereby the material arranged between the grooves forms a crown of a tooth (4).

According to one exemplary embodiment of the invention, it is provided that the grooves (1) are bent. According to a further exemplary embodiment of the invention, it is provided that the crown of a tooth (4) is designed to be coined in order to reduce the size of the open ends (2). According to yet a further exemplary embodiment of the invention, it is provided that winding elements (3) are arranged in the grooves (1), and that at least some of the winding elements (3) have a cross section adapted subsequently to the dimensions of the grooves (1).

The present invention further concerns a method for producing a rotor body having a winding element.

The present invention concerns rotor bodies for an electrical machine, in particular for a starter or starter-alternator, whereby each rotor body comprises grooves having one open end that is provided to house winding elements, and whereby the material arranged between the grooves forms a crown of a tooth. The present invention further concerns a method for producing a rotor body having winding elements.

### BACKGROUND OF THE INVENTION

In the case of electrical machines in the form of starters, for example, pre-manufactured winding elements are inserted radially in open grooves or wound in them directly. To prevent the winding elements from being thrown out, it is already known to secure the conductors belonging to the winding elements by means of clamping between the paper groove covering. Furthermore, the practice of initially beading more or less radially outwardly projecting crowns of teeth for this purpose is known. A secondary impregnation can then be carried out.

In the case of high-speed reduction-gear starters, for example, the production tolerances for the wire, the insulating paper and the armature or rotor laminations make a lateral clamping of the winding elements insufficient to reliably prevent the winding elements or parts thereof from being thrown out. In the case of long rotor cores, even a combination of lateral clamping of the winding elements and local bending of individual laminations in two or three axially offset planes of the rotor core, and the use of support rings over the winding heads is resistant to centrifugation only under certain circumstances. Although good resistance to centrifugation can be obtained by beading initially outwardly projecting crowns of teeth, these narrow, radially overhanging “tabs” are an obstacle to the insertion of the winding elements and, in many cases, lead to a lengthening of the winding heads.

### ADVANTAGES OF THE INVENTION

Due to the fact that one exemplary embodiment of the present invention provides that the grooves are bent, a high resistance to centrifugation is obtained, because the bent side walls of the grooves—in contrast to the related art—do not extend parallel to the centrifugal force acting on the winding elements.

In the case of a preferred exemplary embodiment of the present invention, the grooves are bent in such a fashion that sickle-shaped, parallel-sided grooves result. In this case, the mid-points of the conductors belonging to the winding elements in a groove preferably lie on a line bent in the shape of an S.

It can be further provided that the crown of the tooth is designed to be coined in order to reduce the size of the open ends of the grooves. By coining the crown of the tooth in this fashion, the diameter inside the open ends can be reduced, by way of which additional resistance to centrifugation can be obtained.

The crown of the tooth can comprise a ridge, and/or a recess can be associated with each tooth so that the coining of the crown of the tooth can be carried out particularly effectively. The ridge extends preferably approximately coaxially to the axis of rotation of the rotor and is preferably arched initially outwardly before coining. During coining, the ridge widens, and a semi-closed groove is formed, for example. If a recess is associated with every tooth, the coining procedure can be carried out with less force, because the preferably outwardly arched ridge of the crown of the tooth can extend into the recesses when coined.

After coining, a rotor body is obtained in which winding elements are arranged in the grooves, and in which the crown of the tooth is coined in such a fashion that the diameter of the open ends of the grooves prevents the winding elements from coming out.

The winding elements in the finished rotor body are preferably lodged against the bottom of the grooves. For this purpose, the winding elements can be pressed into the grooves using a hold-down device, for example, during coining of the crown of the tooth. If it is provided that coining is to be carried out on one tooth after another, it suffices for the winding elements arranged in the grooves adjacent to the corresponding tooth to be pressed into the grooves by means of two hold-down devices. Exemplary embodiments are also feasible, of course, in which many or all of the teeth are coined simultaneously using appropriate coining tools, so that the use of a corresponding number of hold-down devices is obvious.

The present invention can furthermore yield a rotor body in which winding elements are arranged in the grooves, and in which at least some of the winding elements comprise a cross section adapted subsequently to the dimensions of the grooves. Such an adaptation of the cross section can be obtained, for instance, by pressing the winding elements into the grooves with a relatively strong force, so that the originally round cross section of the conductors belonging to the winding elements takes on an oval shape. Lateral clamping can be increased markedly in this fashion.

In the case of the rotor body, it can furthermore be provided that at least a few grooves comprise at least one recess in their side walls, which said recess is provided so that at least some of the winding elements can extend in these recesses after the cross section of the winding elements was adapted subsequently to the dimensions of the grooves. For the case in which a separate recess is not provided for every one of the conductors belonging to the winding elements, the recess is preferably provided in the upper, i.e., the radially further outwardly lying, region of the groove.

Due to the fact that a method for producing a rotor body having a winding element according to the present invention comprises the following steps:

a) Provide bent—in particular, sickle-shaped, parallel-sided—grooves in a rotor structure in such a fashion that material arranged between the grooves forms a crown of a tooth, and the grooves comprise an open end in the region of the crown of the tooth,

b) Insert winding elements in the grooves,

c) Place the winding elements against the bottom of the grooves by exerting pressure on the winding elements in the region of the crown of the tooth, and

d) Coin the crown of the tooth in such a fashion that the size of the open ends is reduced so that the winding elements are prevented from coming out, and/or adapt the cross section of at least parts of the winding elements to the dimensions of the grooves,

a rotor body can be produced that has a very high resistance to centrifugation.

Due to the fact that, in the case of a generic rotor body, it is provided that the crown of the tooth is designed to be coined in order to reduce the size of the open ends, a rotor body can also be created that has a high resistance to centrifugation.

When, in particular, the resistance to centrifugation is ensured primarily by coining the crown of the tooth, the crown of the tooth can comprise a ridge, and/or a recess can be associated with every tooth so that the coining of the crown of the tooth can be carried out particularly effectively. The ridge extends preferably approximately coaxially to the axis of rotation of the rotor and is preferably initially arched outwardly before coining. During coining, the ridge widens and a semi-closed groove is formed, for example. If a recess is associated with each tooth, the coining procedure can be carried out with less force, because the preferably outwardly arched ridge of the crown of the tooth extends into the recesses when coined.

After coining, a rotor body is obtained in which winding elements are arranged in the grooves, and in which the crown of the tooth is coined in such a fashion that the diameter of the open ends of the grooves prevent the winding elements from coming out.

The winding elements in the finished rotor body are preferably lodged against the bottom of the grooves. For this purpose, the winding elements can be pressed into the grooves using a hold-down device, for example, during coining of the crown of the tooth. If it is provided that coining is to be carried out on one tooth after another, it suffices for the winding elements arranged in the grooves adjacent to the corresponding tooth to be pressed into the grooves by means of two hold-down devices. Exemplary embodiments are also feasible, of course, in which many or all of the teeth are coined simultaneously using appropriate coining tools, so that the use of a corresponding number of hold-down devices is obvious.

Additionally, when the resistance to centrifugation is ensured primarily by coining the crown of the tooth, it can be advantageous to provide a rotor body in which winding elements are arranged in the grooves, and in which at least some of the winding elements comprise a cross section adapted subsequently to the dimensions of the grooves. Such an adaptation of the cross section can be obtained, for instance, by pressing the winding elements into the grooves with a relatively strong force, so that the originally round cross section of the conductors belonging to the winding elements takes on an oval shape. Lateral clamping can be increased markedly in this fashion.

Even when the resistance to centrifugation is ensured primarily by coining the crown of the tooth, it can be provided—in this context—that at least a few grooves have at least one recess in their side walls that is provided so that at least some of the winding elements extend in these recesses after the cross section of the winding elements was adapted subsequently to the dimensions of the grooves. For the case in which a separate recess is not provided for every one of the conductors belonging to the winding elements, the recess is preferably provided in the upper, i.e., the radially further outwardly lying, region of the groove.

Additionally, when the resistance to centrifugation is ensured primarily by coining the crown of the tooth, it can be provided that the grooves are bent, by way of which the resistance to centrifugation is increased further, because, in this case, the grooves do not extend parallel to the centrifugal force acting on the winding elements.

A shape of the grooves designed in the shape of a sickle and having parallel sides has also been proven particularly advantageous in this case.

Due to the fact that a method, according to the invention, for producing a rotor body having a winding element according to the present invention comprises the following steps:

a) Provide grooves in a rotor structure in such a fashion that material arranged between the grooves forms a crown of a tooth, and the grooves comprise an open end in the region of the crown of the tooth,

b) Insert winding elements in the grooves,

c) Place the winding elements against the bottom of the grooves by exerting pressure on the winding elements in the region of the crown of the tooth, and

d) Coin the crown of the tooth in such a fashion that the size of the open ends is reduced so that the winding elements are prevented from coming out, and/or adapt the cross section of at least parts of the winding elements to the dimensions of the grooves,

a rotor body can also be produced that has a very high resistance to centrifugation.

Due to the fact as well that, in the case of a generic rotor body, one exemplary embodiment of the present invention provides that winding elements are provided in the grooves, and that at least some of the winding elements have a cross section adapted subsequently to the dimensions of the grooves, lateral clamping of the winding elements can be increased markedly, which also yields a rotor body having a high resistance to centrifugation.

When, in particular, the resistance to centrifugation is ensured primarily by adapting the cross section of the winding elements subsequently to the dimensions of the groove, it can be further provided that at least a few grooves have at least one recess in their side walls that is provided so that at least some of the winding elements extend in these recesses after the cross section of the winding elements was adapted subsequently to the dimensions of the grooves. For the case in which a separate recess is not provided for each one of the conductors belonging to the winding elements, the recess is preferably provided in the upper, i.e., the radially further outwardly lying, region of the groove.

Additionally, when the resistance to centrifugation is ensured primarily by the fact that the cross section of the winding elements is adapted subsequently to the dimensions of the groove, it can be provided that the grooves are bent, by way of which the resistance to centrifugation can be increased further because, in this case, the grooves do not extend parallel to the centrifugal force acting on the winding elements.

A shape of the grooves designed in the shape of a sickle and having parallel sides has also been proven particularly advantageous in this case as well.

Additionally, when the resistance to centrifugation is ensured primarily by the fact that the cross section of the winding elements is adapted subsequently to the dimensions of the groove, it can be further provided that the crown of the tooth is designed to be coined in order to reduce the size of the open ends. By coining the crown of the tooth in this fashion, the diameter inside the open ends can be reduced, by way of which additional resistance to centrifugation can be obtained.

The crown of the tooth can comprise a ridge, and/or a recess can be associated with each tooth so that the coining of the crown of the tooth can be carried out particularly effectively. The ridge extends preferably approximately coaxially to the axis of rotation of the rotor and is preferably arched initially outwardly before coining. During coining, the ridge widens, and a semi-closed groove is formed, for example. If a recess is associated with each tooth, the coining procedure can be carried out with less force, because the preferably outwardly arched ridge of the crown of the tooth can extend into the recesses when coined.

After coining, a rotor body is obtained in which winding elements are arranged in the grooves, and in which the crown of the tooth is coined in such a fashion that the diameter of the open ends of the grooves prevent the winding elements from coming out.

Additionally, when the resistance to centrifugation is ensured primarily by the fact that the cross section of the winding elements is adapted subsequently to the dimensions of the groove, the winding elements in the finished rotor body preferably are lodged against the bottom of the grooves. For this purpose, the winding elements can be pressed into the grooves using hold-down devices, for example, during coining of the crown of the tooth. If it is provided that coining is to be carried out on one tooth after another, it suffices for the winding elements arranged in the grooves adjacent to the corresponding tooth to be pressed into the grooves by means of two hold-down devices. Exemplary embodiments are also feasible, of course, in which many or all of the teeth are coined simultaneously using appropriate coining tools, so that the use of a corresponding number of hold-down devices is obvious.

### SUMMARY OF THE DRAWINGS

The invention shall be explained in greater detail hereinbelow with reference to the associated drawings.

FIG. 1 shows a schematic side view of a sector-pattern section of a rotor body according to a first exemplary embodiment of the present invention;

FIG. 2 shows a schematic side view of a sector-pattern section of a rotor body according to a second exemplary embodiment of the present invention;

FIG. 3 shows a schematic side view of a sector pattern section of a rotor body according to a third exemplary embodiment of the present invention; and

FIG. 4 shows a schematic side view of two grooves of a rotor body according to a fourth exemplary embodiment of the present invention.

### DESCRIPTION OF THE PREFERRED EMBODIMENTS

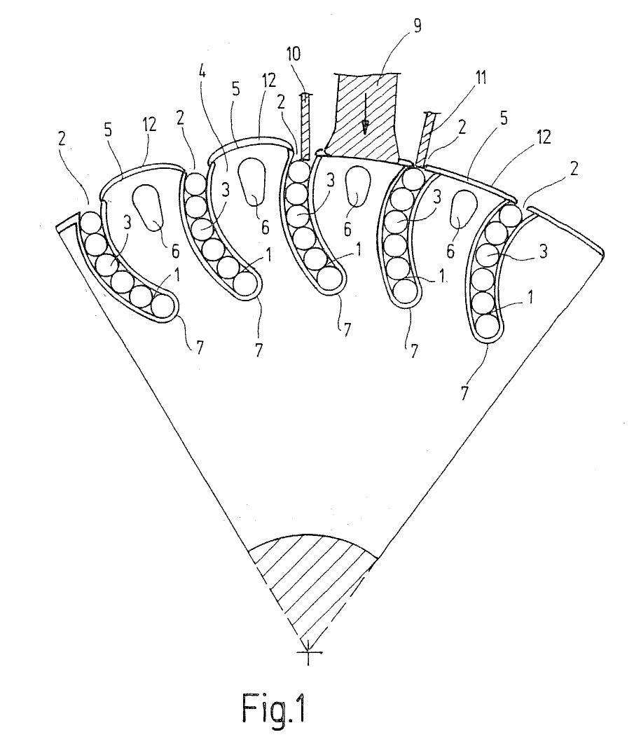

FIG. 1 shows a schematic side view of a sector-pattern section of a rotor body according to a first exemplary embodiment of the present invention. The rotor body shown in FIG. 1 comprises grooves 1, each of which has an open end 2. Winding elements 3 are provided in the grooves 1. The material arranged between the grooves 1 forms a crown of a tooth 4. In the case of the exemplary embodiment of the invention shown in FIG. 1, the grooves 1 are bent in sickle-shaped, parallel-sided fashion. The bent shape of the grooves 1 ensures that the side walls of the grooves 1 do not extend parallel to the centrifugal force acting on the winding elements 3 when the rotor body rotates. This results in a markedly higher resistance to centrifugation.

Furthermore, the crown of the tooth 4 is designed to be coined in order to reduce the inner cross section of the open ends 2. The crown of the tooth 4 comprises a ridge 5 for this purpose, and a recess 6 is associated with each tooth. A coining tool in the form of a coining die 9 is shown in FIG. 1, with which said coining die the crown of the tooth 4 is coined in order to reduce the size of the open ends 2. Referring to FIG. 1, the teeth situated below and to the right of the coining die 9 have already been coined, while the teeth situated to the left of the coining die 9 have not yet been coined. By comparing the coined and non-coined teeth, it is obvious that the ridge 5 is initially outwardly arched before coining. The outwardly arched ridge 5 of the crown of the tooth is pressed into the recess 6 by means of the coining die 9 with relatively little force, so that said ridge widens and forms, and a semi-closed groove 1 is formed, for example. Furthermore, a first hold-down device 10 and a second hold-down device 11 are shown in FIG. 1. These hold-down devices 10, 11 press downwardly on the conductors that are situated in the two grooves 1 adjacent to the tooth to be coined and that are associated with the winding elements 3. In this fashion, it is ensured that the winding elements 3 or the conductors are placed against the bottom of the groove. By placing the winding elements 3 against the bottom 7 of the grooves 1, it is ensured that the rotor body has minimal original imbalance.

If the hold-down devices 10, 11 act on the winding elements 3 with great force, the originally round cross section of the winding elements can be deformed into an oval cross section. Lateral clamping can be increased markedly in this fashion, which also contributes to high resistance to centrifugation. Although this is not shown in FIG. 1, it is also feasible in the case of this exemplary embodiment that at least some of the grooves 1—but preferably all grooves 1—comprise at least one recess in their side walls. This recess would be provided so that at least some of the winding elements 3 extend in these recesses after the cross section of the winding elements 3 was adapted subsequently to the dimensions of the grooves 1 by means of the action of the first and second hold-down devices 10, 11, for example.

The rotor body 1 shown in FIG. 1 can be produced, for example, using the following method for producing a rotor body having a winding elements. Initially, bent grooves 1—that are designed in the shape of a sickle and have parallel sides in the present example—are provided in a rotor structure. The grooves 1 are thereby formed in such a fashion that material arranged between the grooves forms a crown of a tooth 4, and the grooves 1 have an open end 2 in the region of the crown of the tooth 4. The winding elements 3 are then placed in the grooves 1. In preparation for coining, the winding elements 3 arranged in the grooves 1 adjacent to a tooth are placed against the bottom 7 of the grooves 1 by means of the first hold-down device 10 and the second hold-down device 11 in that the first hold-down device 10 and the second hold-down device 11 exert an appropriate amount of force on the winding elements 3. Once the winding elements are placed against the bottom 7 of the grooves 1, the crown of the tooth or a corresponding tooth are coined in such a fashion that the size of the open ends 2 is reduced to the extent that the winding elements 3 are prevented from coming out. Depending on the amount of force that the first hold-down device 10 and the second hold-down device 11 exert on the winding elements 3 in the grooves 1, the cross section of the winding elements 3 is adapted to the dimensions of the grooves 1 when the winding elements 3 are lodged against the bottom 7 of the grooves 7, in order to increase lateral clamping.

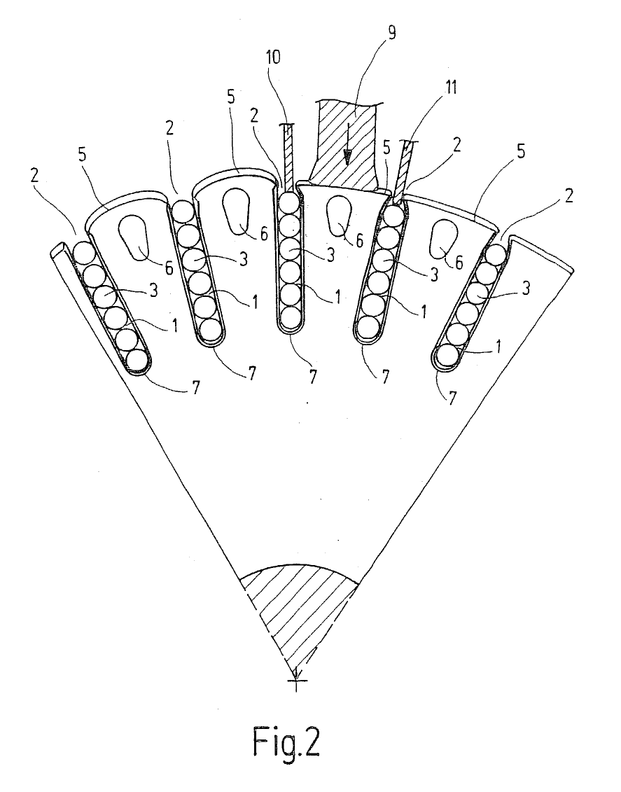

FIG. 2 shows a schematic side view of a sector-pattern section of a rotor body according to a second exemplary embodiment of the present invention. The rotor body shown in FIG. 2 also comprises grooves 1, each of which has an open end 2. Winding elements 3 are provided in the grooves 1. The material arranged between the grooves 1 forms a crown of a tooth 4 in this exemplary embodiment as well. Essentially radially extending grooves 1 are provided in the exemplary embodiment of the rotor body according to the invention shown in FIG. 2. In order to obtain the desired resistance to centrifugation, the crown of the tooth 4 is designed to be coined in order to reduce the internal cross section of the open ends 2. The crown of the tooth 4 comprises a ridge 5 for this purpose, and a recess 6 is associated with each tooth. A coining tool in the form of a coining die is also indicated in FIG. 2, with which said coining die the crown of the tooth is coined in order to reduce the size of the open ends 2. Referring to FIG. 2, the teeth situated below and to the right of the coining die 9 have already been coined, while the teeth situated to the left of the coining die 9 have not yet been coined. By comparing the coined and non-coined teeth, it is obvious that the ridge 5—in this exemplary embodiment as well—is initially arched outwardly before coining. The outwardly arched ridge 5 of the crown of the tooth is pressed into the recess 6 by means of the coining die 9 with relatively little force, so that said ridge widens and forms, and a semi-closed groove 1 is formed, for example. A first hold-down device 10 and a second hold-down device 11 are shown in FIG. 2 as well. These hold-down devices 10, 11 press downwardly on the conductors that are situated in the two grooves 1 adjacent to the tooth to be coined and that are associated with the winding elements 3. In this fashion, it is ensured in the case of this exemplary embodiment as well that the winding elements 3 or the conductors are placed against the bottom of the groove. By placing the winding elements 3 against the bottom 7 of the grooves 1, it is ensured that the rotor body has minimal original imbalance.

In order to further increase the resistance to centrifugation, it can be provided in the case of this exemplary embodiment as well that the hold-down devices 10, 11 act on the winding elements 3 with great force. As a result, the originally round cross section of the winding elements or the conductors can be deformed into an oval cross section. Lateral clamping can be increased markedly in this fashion, which also contributes to high resistance to centrifugation.

The rotor body shown in FIG. 2 can be produced, for example, using the following method for producing a rotor body having winding elements. Initially, radially extending grooves 1 are provided in a rotor structure. The grooves 1 are thereby formed in such a fashion that material arranged between the grooves 1 forms a crown of a tooth 4, and the grooves 1 have an open end 2 in the region of the crown of the tooth 4. The winding elements 3 are then placed in the grooves 1. In preparation for coining, the winding elements 3 arranged in grooves adjacent to a tooth are placed against the bottom 7 of the grooves 1 by means of the first hold-down device 10 and the second hold-down device 11 in that the first hold-down device 10 and the second hold-down device 11 exert an appropriate amount of force on the winding elements 3. Once the winding elements are placed against the bottom 7 of the grooves 1, the crown of the tooth or a corresponding tooth are coined in such a fashion that the size of the open ends 2 is reduced to the extent that the winding elements 3 are prevented from coming out. Depending on the amount of force that the first hold-down device 10 and the second hold-down device 11 exert on the winding elements 3 in the grooves 1, the cross section of the winding elements 3 is adapted to the dimensions of the grooves 1 when the winding elements 3 are lodged against the bottom 7 of the grooves 7, in order to increase Lateral clamping.

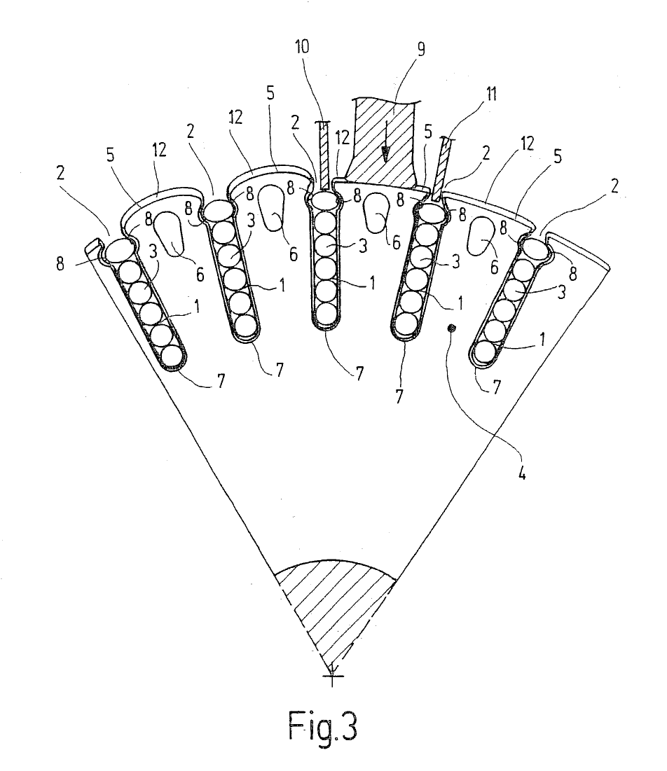

FIG. 3 shows a schematic side view of a sector-pattern section of a rotor body according to a third exemplary embodiment of the present invention. The rotor body shown in FIG. 3 comprises essentially radially extending grooves 1, each of which has an open end 2. Winding elements 3 are provided in the grooves 1. The material arranged between the grooves 1 forms a crown of a tooth 4. In this exemplary embodiment of the present invention, each groove 1 has two recesses in its side walls. Exemplary embodiments are also feasible, of course, in which another number of recesses 8 is provided, e.g., one recess 8 per conductor. The recesses 8 are provided so that at least some of the winding elements 3 extend in these recesses after the cross section of the winding elements 3 was adapted to the dimensions of the grooves 1, e.g., in such a fashion that a positive connection is created, as shown schematically in FIG. 3. The adaptation of the cross section of the winding elements 3 or the corresponding conductors can take place, in the case of this exemplary embodiment as well, by means of the first hold-down device 10 and the second hold-down device 11, which then function in the manner of a coining tool, i.e., they press on the winding elements with relatively great force. This force can thereby be increased slowly so that the winding elements 3 are placed against the bottom 7 of the grooves 1 before their cross section is adapted to that of the grooves 1.

Although a high resistance to centrifugation is already obtained by means of the cross section adapted to the grooves 1, it can be increased even further by designing the crown of the tooth 4 to be coined in order to reduce the size of the internal cross section of the open ends 2, as shown in FIG. 3. For this purpose, the crown of the tooth 4 shown in FIG. 3 also comprises a ridge 5, and a recess 6 is associated with each tooth. A coining tool in the form of a coining die is shown in FIG. 3 as well, by way of which coining die the crown of the tooth is coined to reduce the size of the open ends 2. Referring to FIG. 3, the teeth situated below and to the right of the coining die 9 have already been coined, while the teeth situated to the left of the coining die 9 have not yet been coined. By comparing the coined and non-coined teeth, it is obvious that the ridge 5 is initially arched outwardly before coining. The outwardly arched ridge 5 of the crown of the tooth is pressed into the recess 6 by means of the coining die 9 with relatively little force, so that said ridge widens and forms, and a semi-closed groove 1 is formed, for example. Since the cross section of the winding element is preferably adapted to the grooves before the crown of the tooth is coined—by way of which clamping can be produced between the winding elements 3 and the grooves 1—the (further) use of the hold-down devices 10, 11 can be eliminated if necessary in the case of this exemplary embodiment for coining the crown of the tooth 4 or the individual teeth.

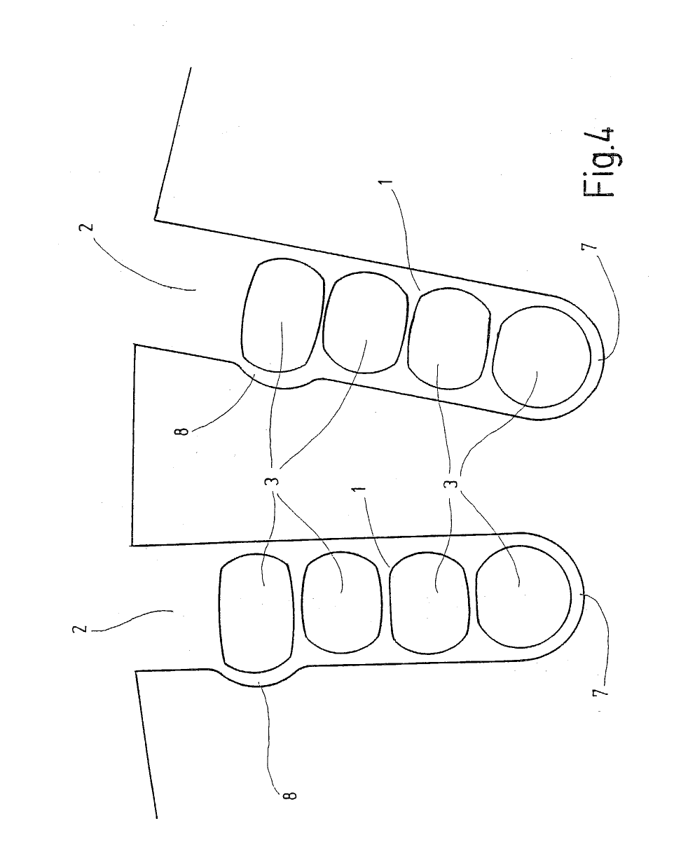

FIG. 4 shows a schematic side view of two grooves of a rotor body according to a fourth exemplary embodiment of the present invention. This exemplary embodiment essentially corresponds to the exemplary embodiment according to FIG. 3 with the exception that each groove 1 has only one recess 8. According to FIG. 4, the cross section of the winding elements 3 is adapted to the cross section of the grooves 1, whereby the uppermost conductors extend in the recesses 8. The distance, shown in FIG. 4, between the winding elements 3 and the grooves 1 is filled, in practice, with not shown insulating material, e.g., a paper groove insulation or the like, so that the desired clamping effect is obtained.

In the case of all exemplary embodiments of the present invention it is feasible that, as long as a coining of the crown of the tooth 4 is performed, many or all of the teeth are coined simultaneously.

It is furthermore to be stated that the providing of bent grooves 1, the coining of the crown of the tooth 4, and the subsequent adaptation of the cross section of the winding elements to the grooves-in particular to grooves comprising recesses-yields a high resistance to centrifugation when considered individually. These measures can be combined in any fashion, however, so that the degree of resistance to centrifugation desired can be adapted to the respective requirements.

The preceding description of the exemplary embodiments according to the present invention is intended for illustrative purposes only and is not intended to limit the invention. Various changes and modifications are possible within the scope of the invention without leaving the scope of the invention or its equivalents.

What is claimed is:

1. A rotor abody for an electrical machine, in particular for a starter or a starter-alternator, whereby the rotor body comprises grooves (1) having one open end (2) that are provided to house winding elements (3), and whereby the material arranged between the grooves (1) forms a crown of a tooth (4), wherein the grooves (1) are bent.

2. The rotor body according to claim 1,
wherein the grooves (1) are designed in the shape of a sickle and have parallel sides.

3. The rotor body according to one of the preceding claims,
wherein the crown of the tooth (4) is designed to be coined in order to reduce the size of the open ends (2).

4. The rotor body according to one of the preceding claims,
wherein the crown of the tooth (4) has a ridge (5), and/or that a recess (6) is associated with each tooth.

5. The rotor body according to one of the preceding claims,
wherein winding elements (3) are arranged in the grooves (1), and
wherein the crown of the tooth (4) is coined in such a fashion that the diameter of the open ends (2) of the grooves (1) prevents the winding elements (3) from coming out.

6. The rotor body according to one of the preceding claims,
wherein the winding elements (3) are lodged against the bottom (7) of the grooves (1).

7. The rotor body according to one of the preceding claims,
wherein winding elements (3) are arranged in the grooves (1), and
wherein at least some of the winding elements (3) have a cross section adapted subsequently to the dimensions of the grooves (1).

8. The rotor body according to one of the preceding claims,
wherein at least some of the grooves (1) have at least one recess (8) in their side walls that is provided so that at least some of the winding elements (3) extend in these recesses (8) after the cross section of the winding elements (3) was adapted subsequently to the dimensions of the grooves (1).

9. A method for producing a rotor body having winding elements,
wherein it comprises the following steps:
a) Provide bent—in particular, sickle-shaped, parallel-sided—grooves (1) in a rotor structure in such a fashion that material arranged between the grooves (1) has a crown of a tooth (4), and the grooves (1) have an open end (2) in the region of the crown of the tooth (4),
b) Insert winding elements (3) in the grooves (1),
c) Place the winding elements (3) against the bottom (7) of the grooves (1) by applying pressure to the winding elements (3) in the region of the crown of the tooth (4), and
d) Coin the crown of the tooth (4) in such a fashion that the size of the open ends (2) is reduced to the extent that the winding elements (3) are prevented from coming out, and/or adapt the cross section of at least parts of the winding elements (3) to the dimensions of the grooves (1).

10. A rotor body for an electrical machine, in particular for a starter or a starter-alternator, whereby the rotor body comprises grooves (1) having one open end (2) that are provided to house winding elements (3), and whereby material arranged between the grooves (1) forms a crown of a tooth (4), wherein the crown of the tooth (4) is designed to be coined in order to reduce the size of the open ends (2).

11. The rotor body according to claim 10,
wherein the crown of the tooth has a ridge (5) provided to be coined, and/or
wherein a recess (6) is associated with each tooth.

12. The rotor body according to claim 10 or 11,
wherein winding elements (3) are arranged in the grooves (1), and
wherein the ridge (5) of the crown of the tooth (4) is coined in such a fashion that the diameter of the open ends (2) of the grooves (1) prevents the winding elements (3) from coming out.

13. The rotor body according to one of the claims 10 through 12,
wherein the winding elements (3) are lodged against the bottom (7) of the grooves (1).

14. The rotor body according to one of the claims 10 through 13,
wherein winding elements (3) are arranged in the grooves (1), and
wherein at least some of the winding elements (3) have a cross section adapted subsequently to the dimensions of the grooves (1).

15. The rotor body according to one of the claims 10 through 14,
wherein at least a few grooves (1) have at least one recess (8) in their side walls that is provided so that at least some of the winding elements (3) extend in these recesses (8) after the cross section of the winding elements (3) was adapted subsequently to the dimensions of the grooves (1).

16. The rotor body according to one of the claims 10 through 15,
wherein the grooves (1) are bent.

17. The rotor body according to one of the claims 10 through 16,
wherein the grooves (1) are designed in the shape of a sickle and have parallel sides.

18. A method for producing a rotor body having winding elements,
wherein it comprises the following steps:
a) Provide grooves (1) in a rotor structure such that material arranged between the grooves (1) forms a crown of a tooth (4), and the grooves (1) have an open end (2) in the region of the crown of the tooth (4),
b) Insert winding elements (3) in the grooves (1),
c) Place the winding elements (3) against the bottom (7) of the grooves (1) by applying pressure to the winding elements (3) in the region of the crown of the tooth (4), and
d) Coin the crown of the tooth (4) in such a fashion that the size of the open ends (2) is reduced so that the winding elements (3) are prevented from coming out, and/or adapting the cross section of at least parts of the winding elements (3) to the dimensions of the grooves (1).

19. A rotor body for an electrical machine, in particular for a starter or a starter-alternator, whereby the rotor body comprises grooves (1) having an open end (2) that are provided to house winding elements (3), and whereby the material arranged between the grooves forms a crown of a tooth (4),
wherein winding elements (3) are arranged in the grooves (1), and
wherein at least some of the winding elements (3) have a cross section adapted subsequently to the dimensions of the grooves (1).

20. The rotor body according to claim 19,
wherein at least a few grooves (1) have at least one recess (8) in their side walls that is provided so that at least some of the winding elements (3) extend in these recesses (8) after the cross section of the winding elements (7) was adapted subsequently to the dimensions of the grooves (1).

21. The rotor body according to claim 20,
wherein the grooves (1) are bent.

22. The rotor body according to claims 20 or 21,
wherein the grooves are designed in the shape of a sickle and have parallel sides.

23. The rotor body according to one of the claims 20 through 22,
wherein the crown of the tooth (4) is designed to be coined in order to reduce the size of the open ends (2).

24. The rotor body according to one of the claims 20 through 23,
wherein the crown of the tooth (4) has a ridge (5) and/or
wherein a recess (6) is associated with each tooth.

25. The rotor body according to one of the claims 20 through 24,
wherein winding elements (3) are arranged in the grooves (1), and
wherein the crown of the tooth (4) is coined in such a fashion that the diameter of the open ends (2) of the grooves (1) prevents the winding elements (3) from coming out.

26. The rotor body according to one of the claims 20 through 25,
wherein the winding elements (3) are lodged against the bottom of the grooves (1).
